(19) United States
(12) Patent Application Publication
(10) Pub. No.: US 2010/0289946 A1
(43) Pub. Date: Nov. 18, 2010

(54) Adaptive de-flicker device and method for adaptive de-flicker

(75) Inventors: Shang-Ming Hung, HsinChu City (TW); Chien-Teng Huang, HsinChu City (TW); Chin-Chou Lee, HsinChu City (TW); Jeng-Feng Lan, HsinChu City (TW); Chun-Huang Lin, HsinChu City (TW); Hao-Ming Hsu, HsinChu City (TW)

Correspondence Address: TUNG & ASSOCIATES / RANDY W. TUNG, ESQ., 838 W. LONG LAKE RD., SUITE 120, BLOOMFIELD HILLS, MI, 48302, US

(73) Assignee: Chip Goal Electronics Corporation, R.O.C.

(21) Appl. No.: 12/657,902

(22) Filed: Jan. 29, 2010

(30) Foreign Application Priority Data
May 18, 2009 (TW) 098116462

(51) Int. Cl. H04N 7/01

(52) U.S. Cl. 348/447; 348/E07.003

(57) ABSTRACT

The present invention discloses an adaptive de-flicker device and a method for adaptive de-flicker. The device comprises: a light sensor for sensing ambient light and generating a corresponding electric signal; and a signal processor coupled to the light sensor, for obtaining a flicker frequency of the ambient light according to the electric signal generated by the light sensor. Preferably, the adaptive de-flicker device further comprises a clock generator coupled to the signal processor, for generating a clock signal relating to the flicker frequency of the ambient light according to an output signal of the signal processor.

### BACKGROUND OF THE INVENTION

1. Field of Invention

The present invention relates to an adaptive de-flicker device and a method for adaptive de-flicker.

2. Description of Related Art

When ambient light comes from an indoor light source instead of a natural light source, a 50 Hz or 60 Hz flicker is generated according to the frequency of a power supply. To capture images by an image capture device (e.g., an image sensor) under such circumstance, it usually requires de-flickering to avoid inconsistency among brightness of the pictures. In general, de-flickering is processed by way of adjusting exposure time, wherein the exposure time is set to an integer multiple of 1/100 second when the frequency of the power supply is 50 Hz, and is set to an integer multiple of 1/120 second when the frequency of the power supply is 60 Hz. To determine the frequency of the ambient light wherein the image capture device is operated, the prior art provides two ways: The first way is to determine the 50 Hz or 60 Hz frequency by the geographical location where an apparatus using the image capture device (e.g., digital camera, digital video recorder, or monitor) is sold. The problem of this approach is that, for certain types of machines such as a digital video recorder, a user may use it in different geographical regions because of traveling. The other way is presently only applicable to a monitor system, wherein a power frequency sensor and a switch circuit is provided in addition to the monitor. The power frequency sensor determines whether the frequency of the power supply is 50 Hz or 60 Hz, and switches the monitor system to a corresponding frequency that is suitable for de-flicker. This approach is subject to a condition that the monitor system has to be placed in a fixed location, and supplied by a local power supply. However, if the machine is supplied by its own battery instead of the local power supply, such as a portable machine (e.g., a digital video recorder), it is not possible to obtain the frequency of the local power supply and to de-flicker accordingly.

In view of the foregoing, the present invention provides an adaptive de-flicker device and a method related thereto.

### SUMMARY OF THE INVENTION

A first objective of the present invention is to provide an adaptive de-flicker device, which can be applied to, for example but not limited to, a system related to capturing images.

Another objective of the present invention is to provide a method for adaptive de-flicker.

To achieve the foregoing objectives, in one perspective of the present invention, it provides an adaptive de-flicker device comprising: a light sensor for sensing ambient light and generating a corresponding electric signal; and a signal processor coupled to the light sensor, for obtaining a flicker frequency of the ambient light according to the electric signal generated by the light sensor.

In one preferable embodiment, the signal processor includes an amplifier amplifying the electric signal generated by the light sensor. The signal processor may further include a filter filtering the amplified electric signal and/or an analog to digital converter performing analog to digital conversion on the amplified electric signal.

In another preferable embodiment, the adaptive de-flicker device further comprises a clock generator coupled to the signal processor, for generating a clock related to the flicker frequency of the ambient light according to an output signal of the signal processor. The clock generator preferably further includes a delay lock loop (DLL) generating a signal with a stable frequency according to a frequency of the output signal of the signal processor. The clock generator further includes a frequency-division circuit coupled to the DLL for performing frequency-division on the signal generated by the DLL.

In another perspective of the present invention, it provides a method for adaptive de-flicker, comprising: sensing ambient light and generating a corresponding electric signal; obtaining a flicker frequency of the ambient light according to a frequency of the electric signal; and de-flickering an image captured by an image capture device according to the flicker frequency of the ambient light.

In one preferable embodiment, the step of obtaining a flicker frequency of the ambient light includes: filtering the electric signal.

The step of obtaining a flicker frequency of the ambient light may further include: amplifying the electric signal before filtering it, and performing analog to digital conversion on the electric signal.

In one embodiment, the foregoing method for adaptive de-flicker further comprises: generating a clock related to the flicker frequency of the ambient light. The step of generating a clock for example includes: sampling the flicker frequency of the ambient light by a sampling frequency, and duplicating the flicker frequency to generate a signal with a stable frequency. In addition, the step of generating a clock may further include: dividing the stable frequency.

The objectives, technical details, features, and effects of the present invention will be better understood with regard to the detailed description of the embodiments below, with reference to the drawings.

### BRIEF DESCRIPTION OF THE DRAWINGS

FIGS. 1 and 2 show two embodiments of the present invention, respectively.

FIGS. 3-8 illustrate several embodiments of the signal processor 20.

FIG. 9 shows an embodiment of the clock generator 30.

FIGS. 10 and 11 illustrate the operation of a DLL 32 in the clock generator 30.

### DESCRIPTION OF THE PREFERRED EMBODIMENTS

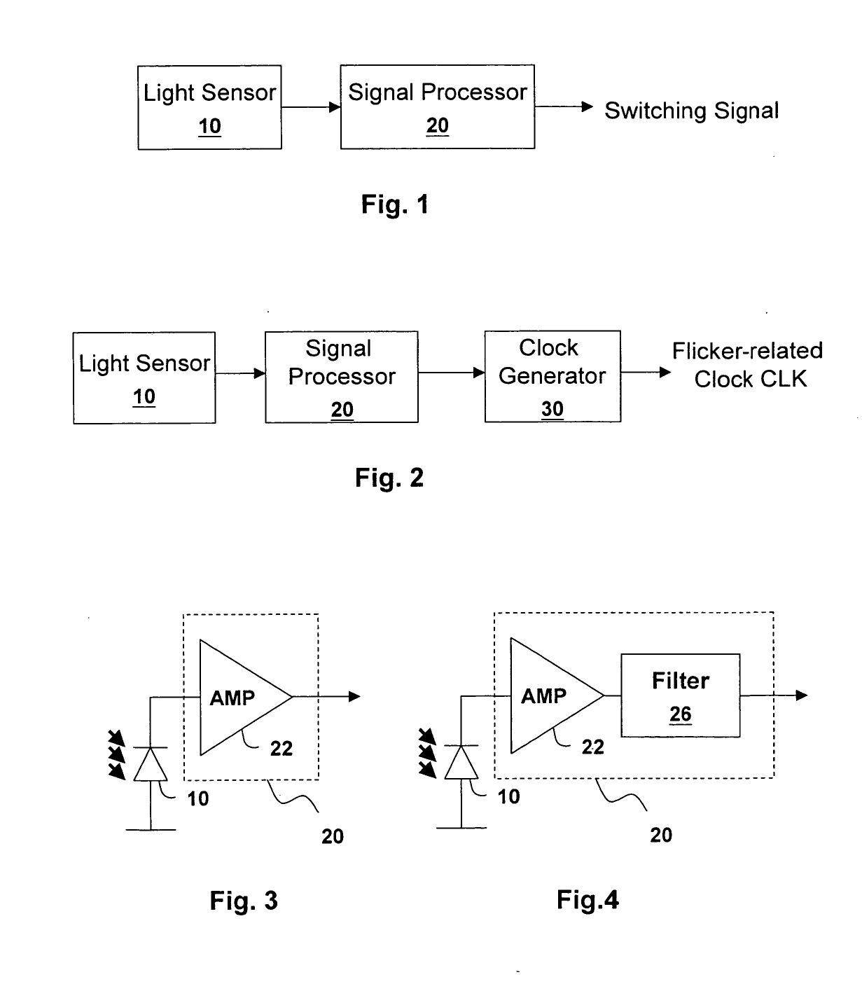

Please refer to FIG. 1, which shows the first embodiment of the present invention. As shown in the drawing, an adaptive de-flicker device of the present invention includes a light sensor 10 and a signal processor 20. The light sensor 10 senses an ambient light and generates a corresponding electric signal. The signal processor 20 obtains a flicker frequency of the ambient light according to an output signal of the light sensor 10. After the flicker frequency is obtained, a switching signal such as a one bit digital signal can be generated, to indicate whether the flicker frequency is 50 HZ or 60 Hz; a subsequent circuit can adjust the exposure time according to the switching signal for de-flicker. Or, the switching signal can be a digital or an analog signal with a flicker frequency, such as a square wave or a sine wave signal, and the subsequent circuit can adjust the exposure time according to the frequency of the switching signal for de-flicker.

FIG. 2 shows another embodiment of the present invention. As shown in the drawing, the adaptive de-flicker device of this embodiment comprises a light sensor 10, a signal processor 20, and a clock generator 30. The light sensor 10 senses ambient light and generates a corresponding electric signal. The signal processor 20 obtains a flicker frequency of the ambient light according to an output signal of the light sensor 10. In this embodiment, after the flicker frequency is obtained, the clock generator 30 generates a clock CLK related to the flicker frequency; for example, when the flicker frequency is 60 Hz, the clock CLK can be 60 Hz, 30 Hz, 20 Hz, etc. Other than used for adjusting the exposure time, this clock CLK can be used a synchronization signal among multiple video cameras taking videos concurrently, or as a line lock frequency.

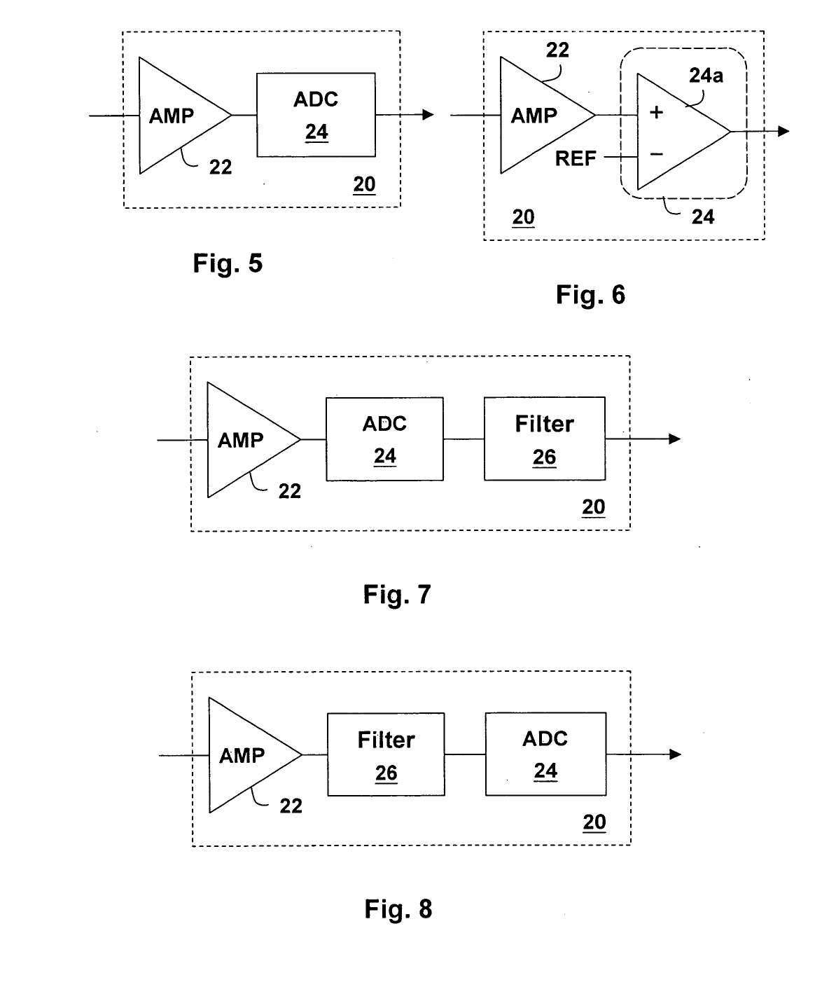

The signal processor 20 can be embodied by various ways, and FIG. 3 illustrates one of the embodiments. The light sensor 10 for example can be a photo diode which generates an electric signal as it receives photons. The signal processor 20 includes an amplifier 22, which amplifies the electric signal generated by the photo sensor 10. This is the simplest form of the signal processor 20 which is capable of outputting an analog signal with a flicker frequency.

FIG. 4 shows another embodiment of the present invention, wherein a filter 26 is further provided next to the amplifier 22. This filter 26 for example can be a low pass filter or a band pass filter for filtering high frequency noises, or for retaining a signal with a frequency in a range from slightly lower than 50 Hz to slightly higher than 60 Hz.

FIG. 5 shows another embodiment of the present invention. For easier signal processing, the signal processor 20 can be further provided with an analog to digital converter 24 for converting the amplified analog signal to a digital signal. The analog to digital converter 24 is not required to be a complicated converter (yet, certainly it may be so), and its simplest form can be only one comparator, such as the comparator 24a in FIG. 6. Thus, the analog signal can be converted to a digital signal.

After the analog signal is converted to the digital signal, it can next be filtered by a filter 26. Or, the analog signal can be filtered by the filter 26 first, and next converted to the digital signal, as shown in FIGS. 7 and 8.

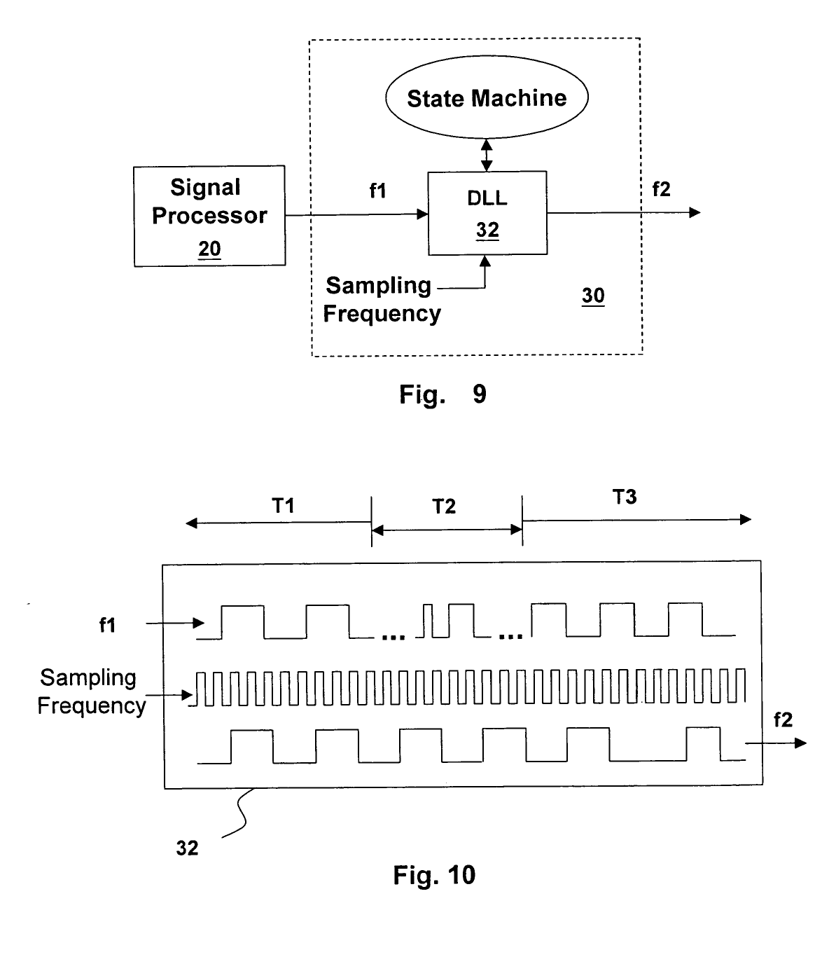

The clock generator 30 can be embodied by various ways, of which one embodiment is shown in FIG. 9. In this embodiment, the clock generator 30 includes a delay lock loop (DLL) 32 which samples the output signal of the signal processor 20 (with a frequency f1) according to a sampling frequency and duplicates it to generate a stable output signal with a frequency f2. Depending on the requirement, the clock generator 30 can be further provided with a frequency division circuit 34 to generate a stable output signal with a frequency f3 according to the signal f2.

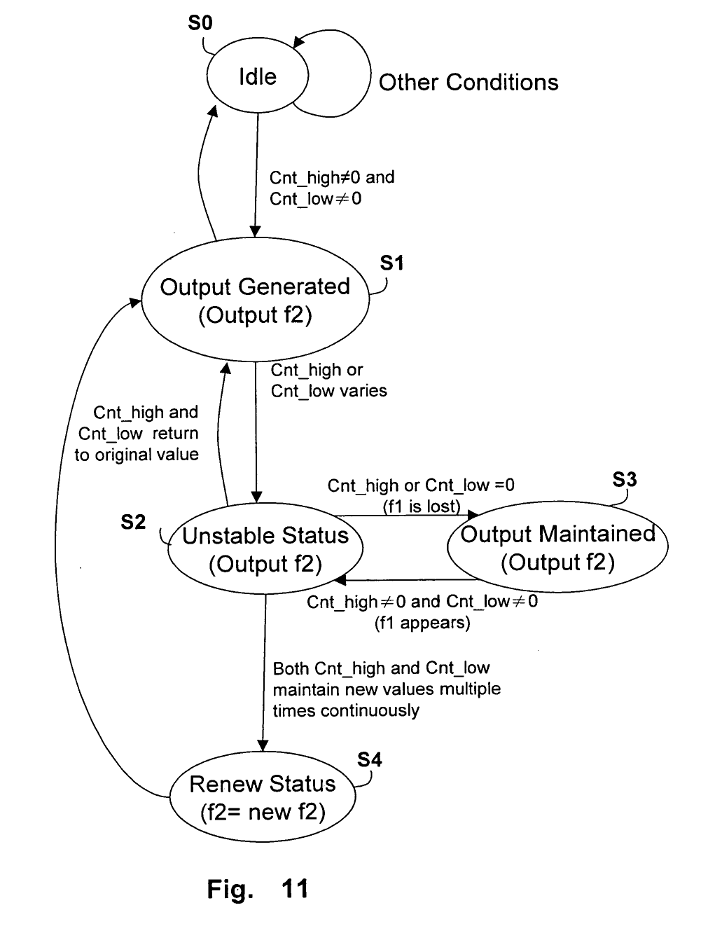

Please refer to FIG. 10. The flicker frequency obtained from the ambient light is not always stable. However, the clock generator 30 formed by the DLL 32 of the present invention can still generate a stable output signal for the subsequent circuit. As shown in FIG. 10, in time period T1, the output signal of the signal processor 20 is in a first stable state (e.g., 50 Hz), and the DLL 32 also generates a signal f2 of a corresponding frequency according to the signal f1. The signal f2 is generated by counting the numbers of high level clocks and low level clocks of the signal f1 by a high frequency sampling signal, and duplicating the length of the high and low levels to generate the signal f2. In time period T2, the output signal of the signal processor 20 is lost or unstable (e.g., when the ambient light is too weak or when the user changes to a new location). In this case, the output signal of the DLL 32 maintains its previous frequency. In time period T3, the output signal of the signal processor 20 changes to a second stable state (e.g., 60 Hz). In this case, after several cycles to confirm the new state, the DLL 32 generates the signal f2 with a corresponding new frequency.

A state machine of the DLL 32 is shown in FIG. 11. In state S0, the DLL 32 is in an idle state. When both the high level clock number (Cnt_high) and the low level clock number (Cnt_low) are not 0, it indicates that the signal f1 is received, so the DLL 32 enters the state S1 and generates the signal f2. When (Cnt_high) or (Cnt_low) varies, the DLL 32 enters the state S2, which is an unstable state, but the DLL 32 maintains the signal f2 with the previous frequency. In the state S2, if (Cn_high) and (Cnt_low) return to the previous value, the DLL 32 returns to the state S1. If either (Cnt_high) or (Cnt_low) is 0, it indicates that the signal f1 is lost, so the DLL 32 enters the state S3, but still maintains the signal f2 with the previous frequency. In the state S3, if both (Cn_high) and (Cnt_low) are not 0, it indicates that the signal f1 appears again; in this case, the DLL 32 returns to the state S2. In the state S2, if (Cn_high) and (Cnt_low) maintain stable new values multiple times, the DLL 32 enters the state S4 such that the signal f2 is changed to a new frequency, and next the DLL 32 returns to the state S1 in which it is operated under the new frequency.

Compared with the prior art, the present invention is more advantageous because it can adaptively sense and eliminate the flicker in the ambient light, which is a great benefit to a portable device. In addition, the present invention can support a function for synchronization or line lock among multiple video cameras.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, any function performed by a single hardware circuit in the drawing can be performed by multiple hardware circuits or software instead. As another example, in the embodiment shown in FIG. 2, a switching signal can be generated from the signal processor 20, in addition to the clock CLK. In view of the foregoing, the spirit of the present invention should cover all such and other modifications and variations, which should be interpreted to fall within the scope of the following claims and their equivalents.

What is claimed is:

1. An adaptive de-flicker device, comprising:
a light sensor for sensing ambient light and generating a corresponding electric signal; and
a signal processor coupled to the light sensor, for obtaining a flicker frequency of the ambient light according to the electric signal generated by the light sensor.

2. The adaptive de-flicker device of claim 1, further comprising a clock generator coupled to the signal processor, for generating a clock related to the flicker frequency of the ambient light according to an output signal of the signal processor.

3. The adaptive de-flicker device of claim 1, wherein the signal processor includes: an amplifier amplifying the electric signal generated by the light sensor.

4. The adaptive de-flicker device of claim 3, wherein the signal processor further includes a filter filtering the amplified electric signal.

5. The adaptive de-flicker device of claim 3, wherein the signal processor further includes an analog to digital converter performing analog to digital conversion on the amplified electric signal.

6. The adaptive de-flicker device of claim 5, wherein the analog to digital converter includes one single comparator.

7. The adaptive de-flicker device of claim 2, wherein the clock generator includes: a delay lock loop (DLL) generating a signal with a stable frequency according to a frequency of the output signal of the signal processor.

8. The adaptive de-flicker device of claim 7, wherein the clock generator further includes a frequency-division circuit coupled to the DLL for performing frequency-division on the signal generated by the DLL.

9. A method for adaptive de-flicker, comprising:
sensing ambient light and generating a corresponding electric signal;
obtaining a flicker frequency of the ambient light according to a frequency of the electric signal; and
de-flickering an image captured by an image capture device according to the flicker frequency of the ambient light.

10. The method of claim 9, further comprising: generating a clock related to the flicker frequency of the ambient light.

11. The method of claim 9, wherein the step of obtaining a flicker frequency of the ambient light includes: filtering the electric signal.

12. The method of claim 11, wherein the step of obtaining a flicker frequency of the ambient light further includes: amplifying the electric signal before filtering it.

13. The method of claim 11, wherein the step of obtaining a flicker frequency of the ambient light further includes: performing analog to digital conversion on the electric signal.

14. The method of claim 10, wherein the step of generating a clock related to the flicker frequency of the ambient light includes: sampling the flicker frequency of the ambient light by a sampling frequency, and duplicating the flicker frequency to generate a signal with a stable frequency.

15. The method of claim 14, wherein the step of generating a clock related to the flicker frequency of the ambient light further includes: dividing the stable frequency.
